(19) United States
(12) Patent Application Publication
(10) Pub. No.: US 2026/0333022 A1
(43) Pub. Date: Oct. 22, 2026

(54) Network Configuration Profile

(71) Applicant: Apple Inc., Cupertino, CA (US)

(72) Inventors: Ahmed Mohamed Ibrahim HASSAN, Munich (DE); Amr Abdelrahman Yousef A MOSTAFA, Neuried (DE); Dirk NICKISCH, Oberpframmern (DE); Gencer CILI, San Jose, CA (US); Nabil AKDIM, München (DE); Sethuraman GURUMOORTHY, San Ramon, CA (US); Srirang A LOVLEKAR, Fremont, CA (US); Thorsten CLEVORN, Munchen (DE)

(21) Appl. No.: 19/113,140

(22) PCT Filed: Sep. 18, 2023
(86) PCT No.: PCT/US2023/032983

§ 371 Date: Mar. 19, 2025

Related U.S. Application Data
(60) Provisional application No. 63/376,646, filed on Sep. 22, 2022.

(51) Int. Cl. H04W 8/24; H04W 72/231; H04W 76/27; H04W 88/06

(52) U.S. Cl. CPC H04W 8/24; H04W 72/231; H04W 76/27; H04W 88/06

(57) ABSTRACT

A user equipment (UE) configured to store one or more configuration profiles in a local database comprising at least a first configuration profile, wherein the first configuration profile includes a set of network configuration parameters and corresponding values and decode, based on signals received from a network, a message indicating that the UE is to apply the set of network configuration parameters and corresponding values stored in the first configuration profile to at least a portion network configuration.

### PRIORITY/INCORPORATION BY REFERENCE

This application claims priority to U.S. Provisional Application Ser. No. 63/376,646 filed on Sep. 22, 2022 and entitled “Network Configuration Profile,” the entirety of which is incorporated herein by reference.

### BACKGROUND

A user equipment (UE) may connect to a fifth generation (5G) new radio (NR) network. During operation, configuring the UE with NR configuration information may consume a relatively large amount of data. It has been identified that the amount of NR configuration data may have an impact on metrics such as UE processing time, UE memory usage, signaling overhead, radio resource consumption, service delay, service activation delay and service interruption duration.

### SUMMARY

Some exemplary embodiments are related to an apparatus of a user equipment (UE), the apparatus having processing circuitry configured to store one or more configuration profiles in a local database comprising at least a first configuration profile, wherein the first configuration profile includes a set of network configuration parameters and corresponding values and decode, based on signals received from a network, a message indicating that the UE is to apply the set of network configuration parameters and corresponding values stored in the first configuration profile to at least a portion network configuration.

Other exemplary embodiments are related to a method performed by a user equipment (UE). The method includes storing one or more configuration profiles in a local database comprising at least a first configuration profile, wherein the first configuration profile includes a set of network configuration parameters and corresponding values and receiving a message from a network, the message indicating that the UE is to apply the set of network configuration parameters and corresponding values stored in the first configuration profile to at least a portion network configuration.

### BRIEF DESCRIPTION OF THE DRAWINGS

FIG. 1 shows an exemplary arrangement according to various exemplary embodiments.

FIG. 2 shows an exemplary user equipment (UE) according to various exemplary embodiments.

FIG. 3 shows an exemplary base station according to various exemplary embodiments.

FIG. 4 illustrates an example of a configuration profile according to various exemplary embodiments.

FIG. 5 shows a signaling diagram for creating a dynamic configuration profile according to various exemplary embodiments.

FIG. 6 illustrates an example of dynamically modifying a predefined configuration profile according to various exemplary embodiments.

FIG. 7 shows a signaling diagram for using a configuration profile with additional changes according to various exemplary embodiments.

FIG. 8 illustrates an example of creating a predefined configuration profile according to various exemplary embodiments.

FIG. 9 illustrates an example of creating a dynamic configuration profile according to various exemplary embodiments.

FIGS. 10a-10b illustrate an example of utilizing a configuration profile according to various exemplary embodiments.

FIGS. 11a-11b illustrate an example of utilizing a configuration profile according to various exemplary embodiments.

FIG. 12 illustrates an example of a creating a configuration profile according to various exemplary embodiments.

FIG. 13 illustrates an example of creating a dynamic configuration profile according to various exemplary embodiments.

FIGS. 14a-14b illustrates an example of utilizing a configuration profile according to various exemplary embodiments.

FIGS. 15a-15b illustrates an example of utilizing a configuration profile according to various exemplary embodiments.

FIG. 16 shows an example of configuration profile template according to various exemplary embodiments.

FIGS. 17a-17b shows an example of utilizing a configuration profile template according to various exemplary embodiments.

### DETAILED DESCRIPTION

The exemplary embodiments may be further understood with reference to the following description and the related appended drawings, wherein like elements are provided with the same reference numerals. The exemplary embodiments introduce mechanisms for configuring a user equipment (UE) with network configuration information in an efficient manner.

The exemplary embodiments are described with regard to a UE. However, reference to the term UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any appropriate type of electronic component.

The exemplary embodiments are also described with regard to a fifth generation (5G) New Radio (NR) network and a next generation node B (gNB). However, reference to a 5G NR network and a gNB is merely provided for illustrative purposes. The exemplary embodiments may be applied to any appropriate type of network and access nodes.

Providing network configuration information to the UE may consume a relatively large amount of data. It has been identified that the amount of network configuration data may have an impact on metrics such as UE processing time, UE memory usage, signaling overhead, radio resource consumption, service delay, service activation delay and service interruption duration. In the examples provided below, the network configurations may be comprised of NR configuration information and/or radio resource control (RRC) configuration information. However, while the exemplary embodiments introduced herein provide benefits for managing NR configuration information, the exemplary embodiments are not limited to NR and may be applied to any appropriate type of network.

In addition, the UE may be configured with a maximum overall RRC configuration size that the UE is required to store. Thus, not only does the amount of network configuration data have an impact on important metrics, but it may also be beneficial to improve the manner in which the UE is configured with network configuration information since the UE may only be required or expected to store a limited amount of network configuration data (e.g., maximum overall RRC configuration size). By improving the manner in which the UE is configured with network configuration information, the network may be able to provide the UE with more useful configuration information but still not exceed the maximum overall RRC configuration size that the UE is required to store.

According to some aspects, the exemplary embodiments introduce mechanisms for reusing certain NR configurations. For example, it has been identified that certain parameters are sent to the UE over and over again in RRC messages. In many scenarios, the configurations are resent to convey minor changes to parameter values or even when no changes have occurred to the parameter values. The exemplary embodiments introduced herein enable the UE to reuse some or all of previously provisioned network configuration information which allows the network to limit the amount of configuration information signaled over the air to the UE.

The exemplary embodiments introduce a configuration profile. Throughout this description, the term “configuration profile” may refer to a set of network configuration parameters and corresponding values. Those skilled in the art will understand that reference to a value in this context does not necessarily mean a numerical value and may generally refer to any specific type of information used to define a parameter. For example, the value may be a placeholder and a specific numerical value or setting may be filled in at a later time. In some embodiments, a configuration profile may be associated with a unique identifier or index referred to as a “profile ID.” However, reference to the terms configuration profile and profile ID are merely provided for illustrative purposes, different entities may refer to similar concepts by different names.

As will be described in more detail below, the UE may store one or more configuration profiles in a local database. During operations, the UE 110 may be triggered to use stored configuration information (e. g., a configuration profile) which may reduce the amount of configuration information transmitted to the UE 110 over the air. In addition, the exemplary embodiments include techniques for utilizing and maintaining a configuration profile. Each of the exemplary embodiments described herein may be used independently from one another, in conjunction with other currently implemented mechanism related to providing the UE with network configuration information, future implementations of mechanisms related to providing the UE with network configuration information and independently from other mechanisms related to providing the UE with network configuration information.

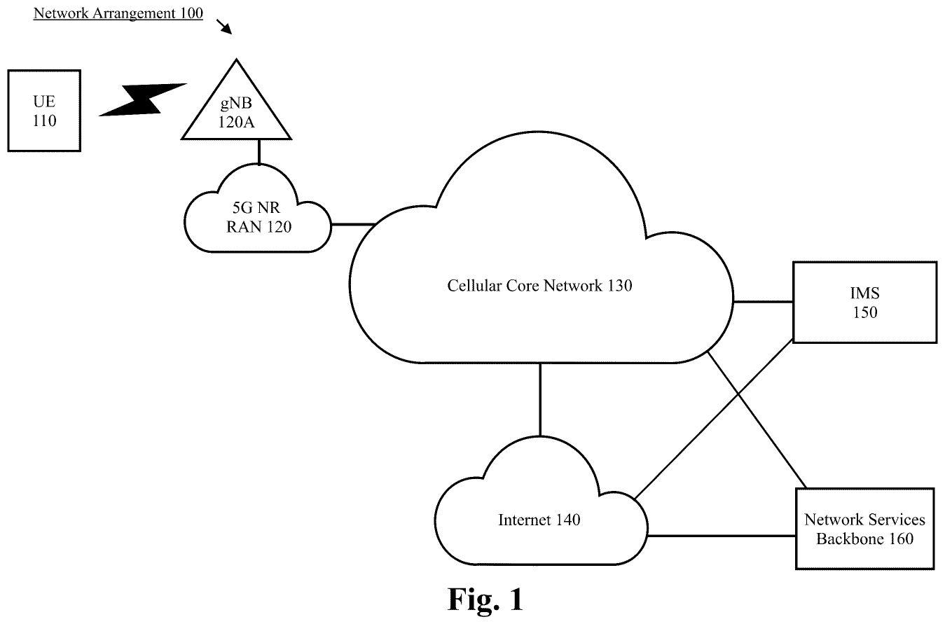

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network arrangement 100, the network with which the UE 110 may wirelessly communicate is a 5G NR radio access network (RAN) 120. However, the UE 110 may also communicate with other types of networks (e.g., a sixth generation (6G) network, a 5G cloud RAN, a next generation RAN (NG-RAN), a long-term evolution (LTE) RAN, a legacy cellular network, a wireless local area network (WLAN), etc.) and the UE 110 may also communicate with networks over a wired connection. With regard to the exemplary embodiments, the UE 110 may establish a connection with the 5G NR RAN 120. Therefore, the UE 110 may have at least a 5G NR chipset to communicate with the 5G NR RAN 120.

The 5G NR RAN 120 may be a portion of a cellular network that may be deployed by a network carrier (e. g., Verizon, AT&T, T-Mobile, etc.). The 5G NR RAN 120 may include, for example, base stations or access nodes (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

Those skilled in the art will understand that any association procedure may be performed for the UE 110 to connect to the 5G NR RAN 120. For example, as discussed above, the 5G NR RAN 120 may be associated with a particular cellular provider where the UE 110 and/or the user thereof has a contract and credential information (e.g., stored on a subscriber identity module (SIM) card). Upon detecting the presence of the 5G NR RAN 120, the UE 110 may transmit the corresponding credential information to associate with the 5G NR RAN 120. More specifically, the UE 110 may associate with a specific base station, e.g., the gNB 120A.

The network arrangement 100 also includes a cellular core network 130, the Internet 140, an IP Multimedia Subsystem (IMS) 150, and a network services backbone 160. The cellular core network 130 may refer an interconnected set of components that manages the operation and traffic of the cellular network. It may include the evolved packet core (EPC) and/or the 5G core (5GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

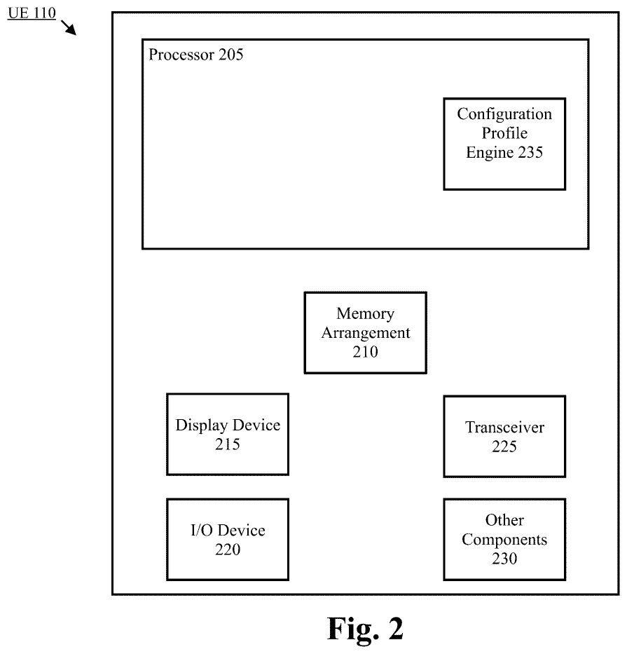

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a configuration profile engine 235. The configuration profile engine 235 may perform various operations such as, but not limited to, receiving network configuration information, storing one or more configuration profiles in a local database, modifying a stored configuration profile, adding information to a stored configuration profile and deleting a stored configuration profile.

The above referenced engine 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engine may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

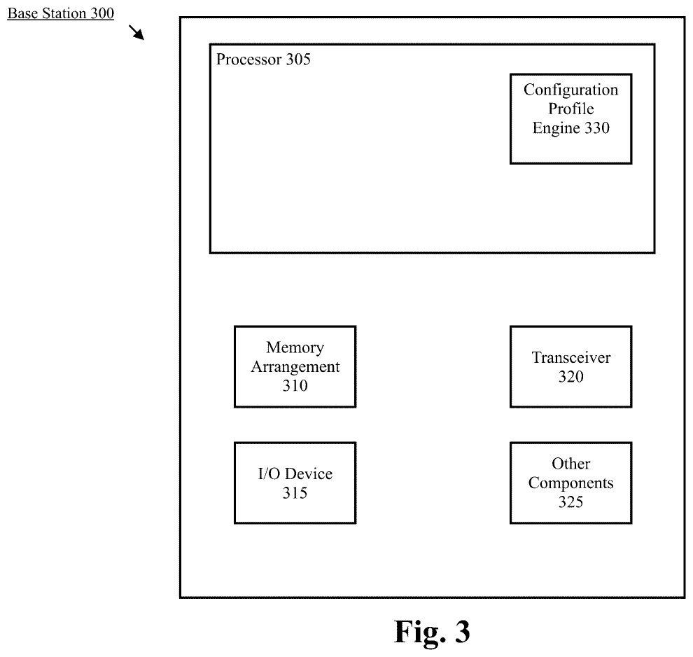

FIG. 3 shows an exemplary base station 300 according to various exemplary embodiments. The base station 300 may represent the gNB 120A or any other type of access node through which the UE 110 may establish a connection and manage network operations.

The base station 300 may include a processor 305, a memory arrangement 310, an input/output (I/O) device 315, a transceiver 320, and other components 325. The other components 325 may include, for example, an audio input device, an audio output device, a battery, a data acquisition device, ports to electrically connect the base station 300 to other electronic devices and/or power sources, transceiver chains, antenna elements, etc.

The processor 305 may be configured to execute a plurality of engines for the base station 300. For example, the engines may include a configuration profile engine 330. The configuration profile engine 330 may perform operations such as, but not limited to, transmitting network configuration information to the UE 110, overwriting information in a configuration profile stored locally at the UE 110 and transmitting an indication that a particular configuration profile is to be used by the UE 110.

The above noted engine 330 being an application (e.g., a program) executed by the processor 305 is only exemplary. The functionality associated with the engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e. g., a baseband processor, an applications processor, etc.). The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300.

The transceiver 320 may be a hardware component configured to exchange data with the UE 110 and any other UE in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs. The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

Some of the exemplary embodiments are described with regard to RRC. Those skilled in the art will understand that “RRC” refers to radio resource control protocols used between the UE 110 and a base station. During operation, the UE 110 may be considered to be in one of multiple different types of RRC modes (or states), e. g., RRC idle mode, RRC inactive mode, RRC connected mode, etc. In RRC connected state, the UE 110 and the 5G NR RAN 120 may be configured to exchange information and/or data. The exchange of information and/or data may allow the UE 110 to perform functionalities available via the network connection. Further, In RRC idle mode the UE 110 is generally not exchanging data with the network and radio resources are not being assigned to the UE 110 within the network. In RRC inactive state, the UE 110 maintains an RRC connection while minimizing signaling and power consumption. However, when the UE 110 is in RRC idle state or RRC inactive state, the UE 110 may monitor for information and/or data transmitted by the network. Throughout this description these terms are being used generally to describe states the UE 110 may be in when connected to any network and that exhibit the characteristics described above for the RRC idle, RRC connected and RRC inactive states.

The exemplary embodiments introduce a configuration profile comprising a set of network configuration parameters and corresponding values. In addition, the exemplary embodiments introduce techniques for utilizing and maintaining configuration profiles stored locally at the UE 110. Each of the exemplary embodiments are described in more detail below.

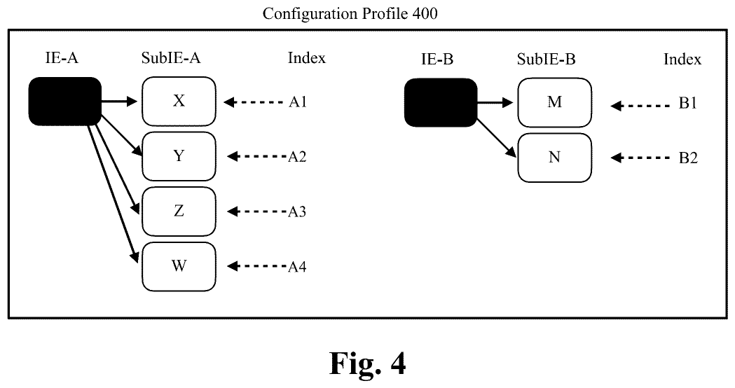

FIG. 4 illustrates an example of a configuration profile 400 according to various exemplary embodiments. In this example, the configuration profile includes RRC IEs and corresponding values. Those skilled in the art will understand that an IE may include configuration information and/or one or more IEs. Throughout this description, the term “sub-IE” may be used to refer to an IE that may be part of another IE.

The configuration profile 400 includes a first IE (IE-A) and a second IE (IE-B). IE-A comprises four sub-IEs indexed A1-A4. In this example, the value for sub-IE A1 is (X), the value for sub-IE A2 is (Y), the value for sub-IE A3 is (Z) and the value for sub-IE A4 is (W). IE-B comprises two sub-IEs indexed B1-B2. In this example, the value for sub-IE B1 is (M) and the value for sub-IE B2 is (N). Although not shown in the configuration profile 400, a sub-IE may include one or more sub-IEs. For example, the value (M) for sub-IE B1 may represent two sub-IEs each set to a specific value. The example configuration profile 400 is not intended to limit the exemplary embodiments in any way. Instead, the exemplary configuration profile 400 is provided as one general example of how parameters and corresponding values may be arranged in a configuration profile.

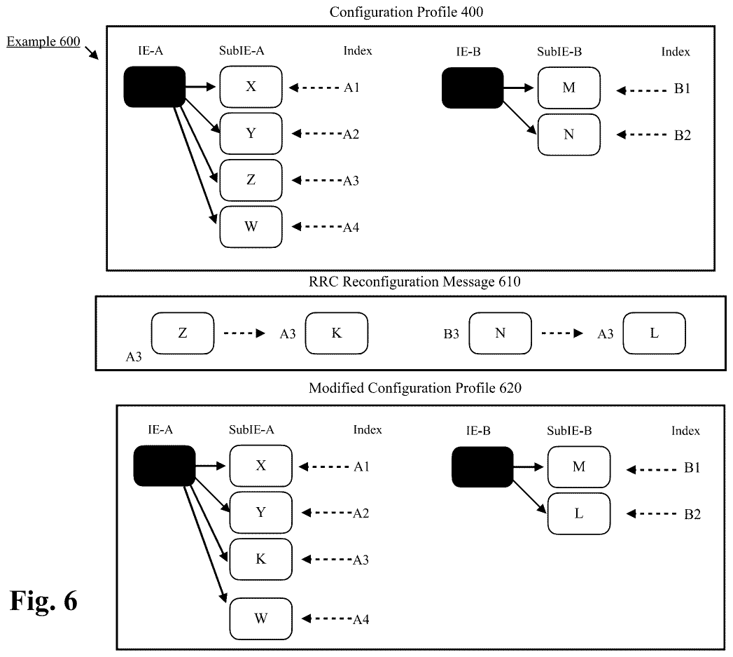

Throughout this description, various examples characterize a configuration profile as being comprised of one or more IEs and/or one or more sub-IEs (e.g., the configuration profile 400, etc.) . Examples described within the context of a configuration profile comprised of IEs and/or sub-IEs are provided below with regard to FIGS. 6 and 8-15. However, a configuration profile is not required to be comprised of IEs and sub-IEs. The exemplary embodiments may be applied to a configuration profile comprised of network configuration information arranged in any appropriate manner.

As will be described in more detail below, the UE 110 may maintain a local database comprising configuration profiles differentiated from one another using a profile ID. During operation, the UE 110 may utilize a stored configuration profile. This may allow the network to avoid signaling the same network configuration information to the UE 110 over and over again.

According to some aspects, a configuration profile may be predefined. For instance, third generation partnership program (3GPP) Specifications may define multiple different configuration profiles. Each configuration profile may comprise a group of one or more RRC IEs with defined values. The network may trigger the UE 110 to apply a particular predefined configuration profile instead of explicitly signaling all of the IEs and values to the UE 110 over the air. To provide a general example, a downlinkConfigCommon IE which is comprised of multiple IEs (e.g., sub-IEs) such as, but not limited to, carrier bandwidth, mapping type, initial downlink bandwidth part (BWP) and carrier bandwidth may be frequently configured by a network operator with the same specific values. In accordance with the exemplary embodiments introduced herein, a configuration profile comprising downlinkConfigCommon IE parameters and specific values may be defined in the 3GPP Specifications. Thus, the network may indicate to the UE 110 which predefined configuration profile should be used by the UE 110 instead of transmitting the downlinkConfigCommon IE and the specific parameter values.

In another approach, a predefined configuration profile may be provided to the UE 110 at any time from any appropriate source remote to the UE 110. The UE 110 may store a predefined configuration profile in a local database and the network may trigger the UE 110 to utilize a predefined configuration profile instead of explicitly transmitting the parameters and their corresponding values to the UE 110. To provide an example, the cellular network or any other appropriate type of network (e.g., wireless local area network (WLAN), WiFi, non-3GPP access network, etc.) may provision the UE 110 with a configuration profile. It may be beneficial to provision the UE 110 with this information when there are no time critical processing requirements on the UE 110. However, the exemplary embodiments may apply to a configuration profile being provided to the UE 110 in any appropriate manner. Subsequently, the network may transmit an indication to the UE 110 that the UE 110 is to utilize a stored configuration profile for a portion of the RRC configuration.

In a further approach, a geolocation-based configuration profile may be implemented. For example, a carrier may predefine configuration profiles per UE capability. The network may provide a configuration profile to UEs when the UEs enters a particular location. The configuration profile may be provided to the UE 110 in in a new system information block (SIB) introduced for this purpose, a currently defined SIB configured to include this type of information or provided using push config IE transported over the data plane. In other examples, the configuration profile may be downloaded from a remote server over a WLAN (e.g., WiFi, etc.) or cellular connection. However, the exemplary embodiments are not limited to the examples provided above and may utilize a configuration profile provided to the UE 110 in any other appropriate manner. Subsequently, the network may indicate to the UE 110 that a configuration profile should be used by the UE 110 for at least a portion of a network configuration.

In some embodiments, the network may compress the abstract syntax notation one (ASN.1) encoded RRC configurations for one or more configuration profiles. Upon entering RRC connected mode on a particular cell, the UE 110 may decompress relevant configuration profiles from its database of stored configuration profiles. This may allow the UE 110 to limit the storage space occupied by configuration profiles.

In other embodiments, the UE 110 may store operator specific predefined configuration profiles in a SIM. This enables operators to pre-assign different configurations upfront and without using radio resources. In this example, the configuration profiles may be associated with a home PLMN (HPLMN), an equivalent PLMN (EPLMN), an operator PLMN (OPLMN) or any other appropriate type of network.

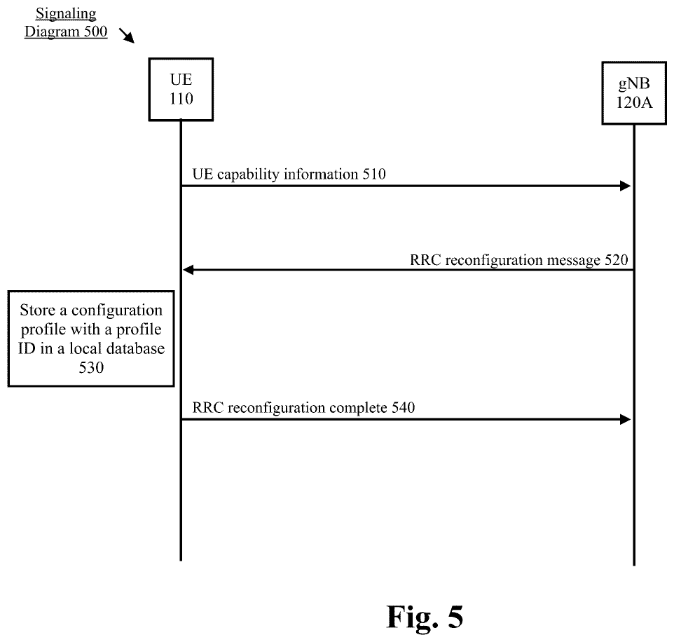

According to other aspects, a configuration profile may be dynamically created. For instance, the UE 110 may indicate to the network a number of configuration profiles that may be supported by the UE 110 (e.g., stored for later use, etc.). The UE 110 may provide this information in capability information or any other appropriate type of message. During RRC configuration, the network may tag one or more IEs with an identifier (e.g., profile ID, index, etc.) or any other appropriate type of indication that an IE is to be stored in a particular configuration profile. The UE 110 may then store dynamically created configuration profiles in a local database of configuration profile each tagged with a unique identifier. An example of this is described in more detail below with regard to the signaling diagram 500 of FIG. 5.

FIG. 5 shows a signaling diagram 500 for creating a dynamic configuration profile according to various exemplary embodiments. The signaling diagram 500 includes the UE 110 and the gNB 120A.

In 510, the UE 110 transmits UE capability information to the gNB 120A. The capability information may, at least in part, indicate how many different configuration profiles may be supported by the UE 110 at the same time. In some embodiments, the capability information may indicate an amount of configuration stored at the UE 110 (e.g., a supported size of stored ASN.1 configuration profile, etc.). To provide an example, the UE 110 may indicate to the network that the UE 110 may store up to (N) different configuration profiles and a total size of all configuration profiles in ASN.1 encoded format is (M) kilobytes (KB). This provides the network with flexibility to provide the UE 110 with up to N configuration profiles without exceeding the total size M.

In 520, the UE 110 receives an RRC reconfiguration message from the gNB 120A. The RRC reconfiguration message may comprise one or more IEs with specific parameter values. The network may tag one or more IEs with a unique ID and each unique ID may represent a configuration profile. For example, the RRC reconfiguration message may include a downlinkConfigCommon IE comprised of multiple sub-IEs (e. g., carrier bandwidth, mapping type, initial downlink bandwidth part (BWP), carrier bandwidth, etc.) with specific parameter values. The downlinkConfigCommon IE may be tagged with a unique ID (e. g., ID #1).

In 530, the UE 110 stores a configuration profile tagged with the unique ID in a local database for later use. In addition, each parameter of the configuration profile may be indexed or associated with a unique identifier. Although not shown in this example, in an actual deployment scenario, the UE 110 may receive multiple unique IDs each associated with a different group of one or more IEs.

In 540, the UE 110 transmits an RRC reconfiguration complete message to the gNB 120A. After the signaling diagram 500, the network may transmit another RRC reconfiguration message to the UE 110 with an indication that the configuration profile dynamically created in 530 is to be utilized. For example, the network may transmit another RRC reconfiguration message to the UE 110 at a subsequent time for any of a variety of different reasons (e.g., update a previously configured configuration profile, create a new configuration profile, delete a previously stored configuration profile, etc.). If the network wants to configure the UE 110 with the same parameter values, instead of retransmitting all of the data that was provided in 520, the network may indicate to the UE 110 that the configuration profile dynamically created in 530 is to be utilized. The configuration profile created in 530 may or may not have been subject to additional changes since 530. The signaling diagram 500 is described within the context of RRC reconfiguration. However, the exemplary embodiments are not limited to RRC reconfiguration and may utilize any appropriate type of message (RRC or otherwise) to configure the UE 110 with a dynamically created configuration profile.

In another approach, a predefined configuration profile may be dynamically modified. For example, the UE 110 may be provisioned with a predefined configuration profile using any of the embodiments described above or in any other appropriate manner. During operation, the network may trigger the UE 110 to overwrite one or more of the parameter values in a configuration profile stored locally at the UE 110. An example of this scheme is described in more detail below with regard to FIG. 6.

FIG. 6 illustrates an example of modifying a predefined configuration profile according to various exemplary embodiments. The example 600 includes the configuration profile 400 of FIG. 4.

In this example, the gNB 120A may transmit an RRC reconfiguration message 610 to the UE 110. The RRC reconfiguration messages 610 may indicate to the UE 110 that the value of sub-IE A-3 is to be changed from Z to K and the value of sub-IE B2 is to be changed from N to L.

The UE 110 modifies the predefined configuration profile in response to the RRC reconfiguration message 610. In the example 600, the modified configuration profile 620 has almost the same contents as the predefined configuration profile 400. However, the value of sub-IE indexed A3 has been changed to K and the value of sub-IE indexed B2 has been changed to L based on the RRC reconfiguration message.

As demonstrated above, in some embodiments, during an RRC reconfiguration procedure, the network may reuse a locally stored configuration profile. For example, an RRC reconfiguration message may comprise an identifier (e.g., profile ID, index, etc.) associated with one or more IEs. The identifier may indicate to the UE 110 which locally stored configuration profile is to be utilized. In some embodiments, the network may reuse a configuration profile as a base and change some parameter values for a subsequent use. However, the changes may not be permanent, and the stored configuration profile may retain the original parameter values. In other embodiments, the UE 110 may conditionally select which stored configuration profile is to be utilized and transmit an indication of the selected configuration profile to the network. The basis on which the UE 110 selects the stored configuration profile may be configured by the network. To provide some non-limiting examples, the UE 110 may select a configuration profile based on a time parameter, a location parameter, a radio environment, traffic conditions, user-based activity or any other appropriate type of one or more conditions.

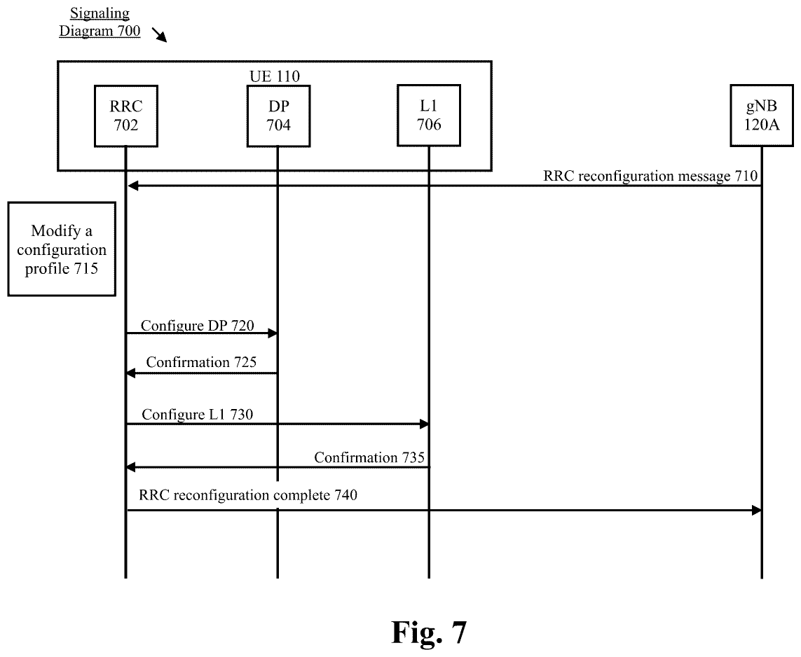

In further embodiments, the network may reuse an already configured configuration profile as a base and add one or more parameters and corresponding values to the configuration profile, delete one or more parameters from the configuration profile and/or modify one or more parameter values of the configuration profile. An example of this scheme is described in more detail below with regard to the signaling diagram 700 of FIG. 7.

FIG. 7 shows a signaling diagram 700 for modifying a configuration profile according to various exemplary embodiments. The signaling diagram 700 includes a UE 110 and the gNB 120A. The UE 110 further includes an RRC entity 702, a data plane (DP) entity 704 and a layer 1 (L1) entity 706.

Initially, assume that the UE 110 stores one or more configurations profiles in a local database each tagged with a unique profile ID. In this example, the one or more configuration profiles may be provided to the UE 110 in any appropriate manner.

In 710, the gNB 120A transmits an RRC reconfiguration message to the UE 110 (e.g., RRC entity 702). The RRC reconfiguration message may include a profile ID (e.g., ID-1) for one of the configuration profiles stored locally at the UE 110. This may indicate to the UE 110 that the configuration profile associated with the profile ID is to be used by the UE 110. The RRC reconfiguration message may also include an indication that one or more IEs and corresponding parameter values are to be added to the configuration profile identified by the profile ID. In addition, the RRC reconfiguration messages may also include an indication that one or more parameter values currently stored in the configuration profile are to be changed to different values and/or deleted from the configuration profile.

In 715, the UE 110 modifies a configuration profile in response to the RRC reconfiguration message. For example, the UE 110 may add IEs and corresponding values to the configuration profile and/or change a stored parameter value to a different value. As indicated above, in some embodiments, the configuration profile may be changed permanently. Thus, the next time the network triggers the UE 110 to use this configuration profile, the configuration profile may be modified in accordance with the changes made in 715. In other embodiments, the configuration profile may be changed for a single use. Thus, the next time the network triggers the UE 110 to use this configuration profile, the configuration profile does not include the modifications made in 715.

In 720, the RRC entity 702 configures the DP entity 704 using the configuration profile. In 725, the DP entity 704 transmits a signal to the RRC entity 702 confirming the configuration. In 730, the RRC entity 702 configures L1 entity 706 using the configuration profile. In 735, L1 entity 706 transmits a signal to the RRC layer 702 confirming the configuration. In 740, the UE 110 transmits an RRC reconfiguration complete message to the gNB 120A.

According to some aspects, a configuration profile may be maintained locally at the UE 110 in accordance with any of a variety of different conditions. For example, a default configuration profile or a predefined configuration profile may be maintained indefinitely by the UE 110 until the network triggers the UE 110 to delete the configuration profile from local storage. In another example, a configuration profile may be maintained based on the RRC mode of the UE 110. For instance, the UE 110 may maintain a dynamic configuration profile only in RRC connected mode and RRC inactive mode. Thus, UE 110 may remove the configuration form the local database when the UE 110 enters RRC idle mode. In a further example, a configuration profile may only be valid and/or maintained in a particular RAN or tracking area (TA). Alternatively, a configuration profile may be valid and/or maintained in all RANs and TAs. In another example, one or more timers may be associated with one or more configuration profiles. When a timer expires, the UE 110 may delete the configuration profile from the local database. However, the above examples are merely provided for illustrative purposes. Each configuration profile may have its own one or more conditions that are to control whether the configuration profile is valid and/or maintained.

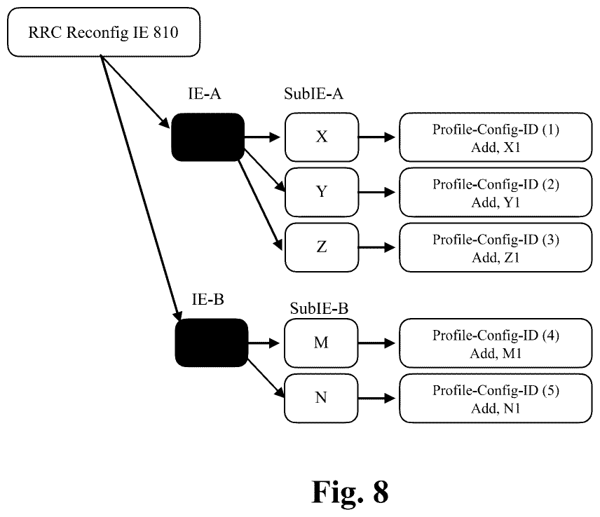

In some of the examples provided above, a configuration profile was characterized as being comprised of RRC IEs and sub-IEs. The examples provided below with regard to FIGS. 8-15 provide additional examples for managing configuration profiles comprised of RRC IEs and/or sub-IEs.

According to some aspects, an IE may be configured to include a parameter (Profile-Config). Profile-Config may include a Profile-Config-ID parameter configured to identify the corresponding configuration profile and an action parameter (Add/Mod/Remove) configured to trigger the UE 110 to add a new configuration profile to its local storage, modify a stored configuration profile or delete a stored configuration profile.

To create a predefined configuration profile, the network may provide the UE 110 with a message comprising an RRC container. The RRC container may include only IEs comprising configuration information that may be reused. A top-level IE for each set of IEs that are to be stored together as a configuration profile may include the parameter Profile-Config. An example of this is described in more detail below with regard to FIG. 8.

FIG. 8 illustrates an example of creating a predefined configuration profile according to various exemplary embodiments.

During operation, the network may provision the UE 110 with one or more predefined configuration profiles. To convey this information to the UE 110, the network may provide the UE 110 with an RRC container comprising network configuration information that may be reused at a subsequent time. The RRC container may include an RRC-Reconfig IE 810 comprising sub-IE X with a Profile-Config parameter and other network configuration information. The Profile-Config parameter may include a Profile-Config-ID set to (1) and an indication that a configuration profile is to be stored locally at the UE 110 comprising sub-IE X and its corresponding network configuration information (X1). Although not shown in this example, X1 and the other network configuration information referenced below (Y1, Z1, M1, N1) may include additional sub-IEs and/or any other appropriate type of configuration information.

The RRC container may further include sub-IE Y with a Profile-Config parameter and other network configuration information. The Profile-Config parameter may include a Profile-Config-ID set to (2) and an indication that a configuration profile is to be stored locally at the UE 110 comprising sub-IE Y and the corresponding network configuration information (Y1). The RRC container may further include sub-IE Z with a Profile-Config parameter and other network configuration information. The Profile-Config parameter may include a Profile-Config-ID set to (3) and an indication that a configuration profile is to be stored locally at the UE 110 comprising sub-IE Z and the corresponding network configuration information (Z1). The RRC container may further include sub-IE M with a Profile-Config parameter and other network configuration information. The Profile-Config parameter may include a Profile-Config-ID set to (4) and an indication that a configuration profile is to be stored locally at the UE 110 comprising sub-IE M and the corresponding network configuration information (M1). The RRC container may further include sub-IE N with a Profile-Config parameter and other network configuration information. The Profile-Config parameter may include a Profile-Config-ID set to (5) and an indication that a configuration profile is to be stored locally at the UE 110 comprising sub-IE N and the corresponding network configuration information (N1).

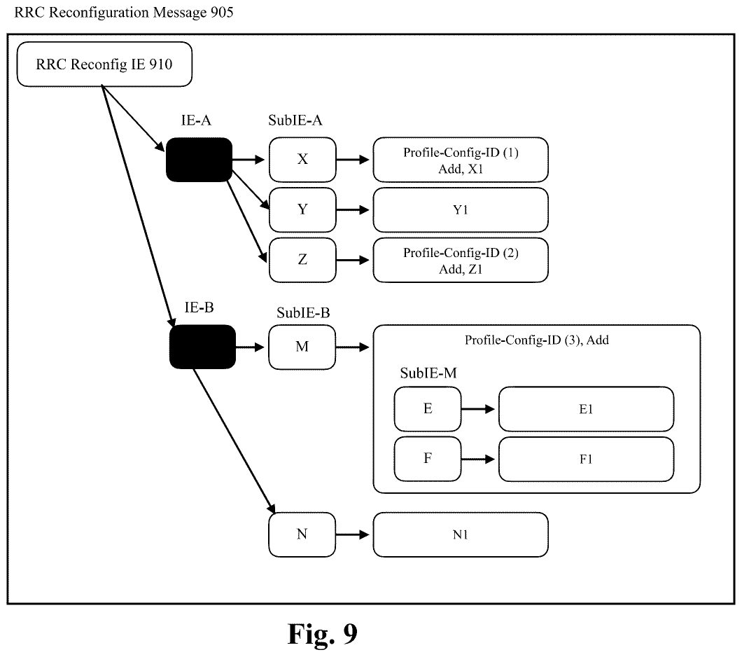

To create a dynamic configuration profile, the network may transmit an RRC message to the UE 110 to convey network configuration information to the UE 110. A top-level IE for each set of IEs that are to be stored together as a configuration profile may include the parameter Profile-Config. An example of this is described in more detail below with regard to FIG. 9.

FIG. 9 illustrates an example of creating a dynamic configuration profile according to various exemplary embodiments. Initially, assume an RRC reconfiguration message 905 with an RRC-Reconfig IE 910 is transmitted to the UE 110 to configure the UE 110. The RRC-Reconfig IE 910 includes at least IE-A comprising sub-IEs X, Y and Z and IE-B comprising sub-IEs M and N. In addition, sub-IE M further includes sub-IEs E and F.

In this example, sub-IEs Y and N are do not include the Profile-Config parameter since their respective network configuration information (Y1) and (N1) is not to be reused. Therefore, the UE 110 does not store this information locally in a configuration profile.

Further, sub-IE X includes a Profile-Config parameter and other network configuration information. The Profile-Config parameter may include a Profile-Config-ID set to (1) and an indication that a configuration profile is to be stored locally at the UE 110 comprising sub-IE X and the corresponding network configuration information (X1). Sub-IE Z includes a Profile-Config parameter and other network configuration information. The Profile-Config parameter may include a Profile-Config-ID set to (2) and an indication that a configuration profile is to be stored locally at the UE 110 comprising sub-IE Z and the corresponding network configuration information (Z1).

Sub-IE M includes the Profile-Config parameter and sub-IEs E and F. The Profile-Config parameter may include a Profile-Config-ID set to (3) and an indication that a configuration profile is to be stored locally at the UE 110 comprising sub-IEs M, E and F and the corresponding network configuration information (E1) and (F1).

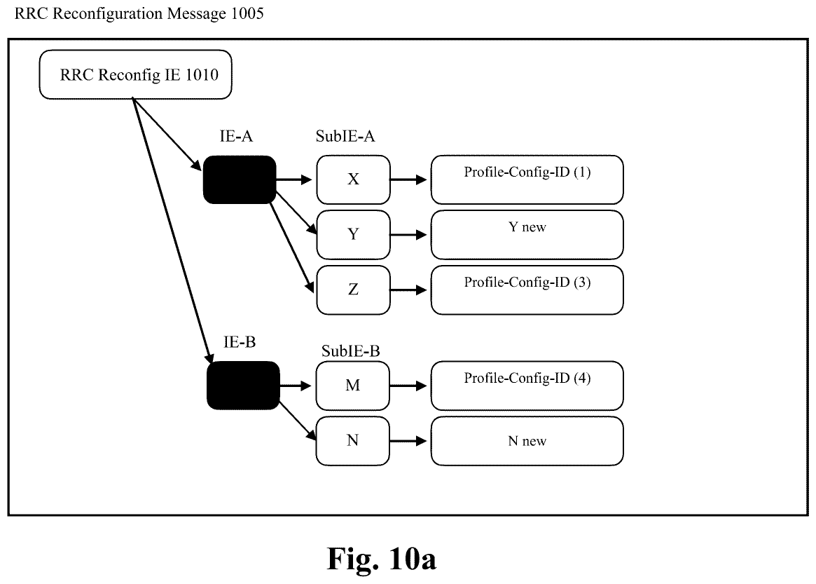

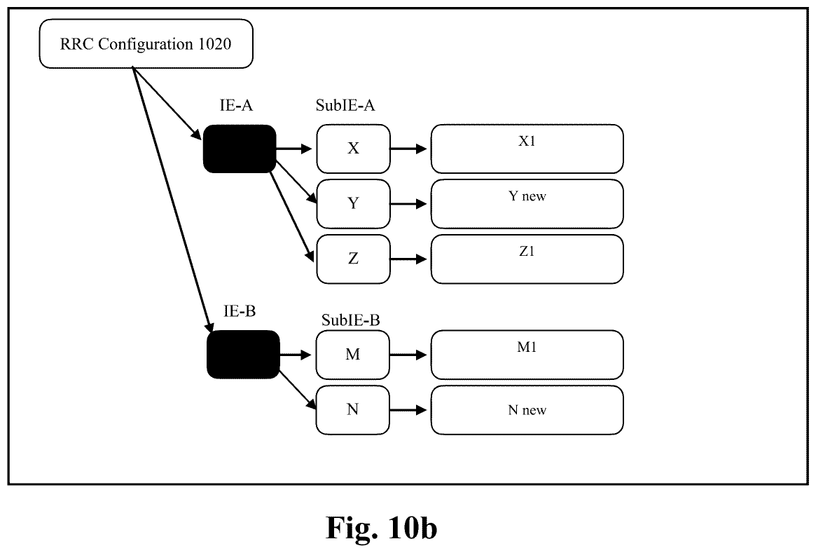

FIGS. 10a-10b illustrate an example of utilizing a configuration profile according to various exemplary embodiments. Initially, assume that the UE 110 has multiple configuration profiles stored in a local database each corresponding to a different Profile-Config-ID. The configuration profiles may be predefined configuration profiles, dynamic configuration profiles or a combination thereof.

FIG. 10a shows an RRC reconfiguration message 1005. During operation, the network may transmit the RRC reconfiguration message 1005 comprising RRC-Reconfig IE 1010 to the UE 110. RRC-Reconfig IE 1010 includes at least IE-A with sub-IEs X, Y and Z and IE-B with sub-IEs M and N. In this example, Sub-IE X is configured to include an indication that Profile-Config-ID (1) is to be utilized. Thus, instead of explicitly providing all of network configuration information typically included in sub-IE X, the network may include an indication that the network configuration information associated with a particular profile ID is to be utilized. Similarly, sub-IEs Z and M each include an indication that the network configuration information associated with a particular profile ID is to be utilized (e.g., Profile-Config-ID (3) and Profile-Config-ID (4)). The sub-IEs Y and N include network configuration information but do not include an indication of a configuration profile.

In response to the RRC reconfiguration message 1005, the UE 110 configures an RRC configuration 1020 as shown in FIG. 10b. The RRC configuration 1020 may apply configuration information included in the RRC-Reconfig IE 1010 and information stored in one or more configuration profiles.

In this example, the UE 110 may set the network configuration associated with sub-IE X to X1 because X1 is the configuration information stored in Profile-Config-ID (1). The UE 110 may set the network configuration associated with sub-IE Y to Ynew because Ynew is the configuration information provided in the RRC-Reconfig IE 1010. The UE 110 may set the network configuration associated with sub-IE Z to Z1 because Z1 is the configuration information stored in Profile-Config-ID (3). The UE 110 may set the network configuration associated with sub-IE M to M1 because M1 is the configuration information stored in Profile-Config-ID (4). The UE 110 may set the network configuration associated with sub-IE N to Nnew because Nnew is the configuration information provided in the RRC-Reconfig IE 1010.

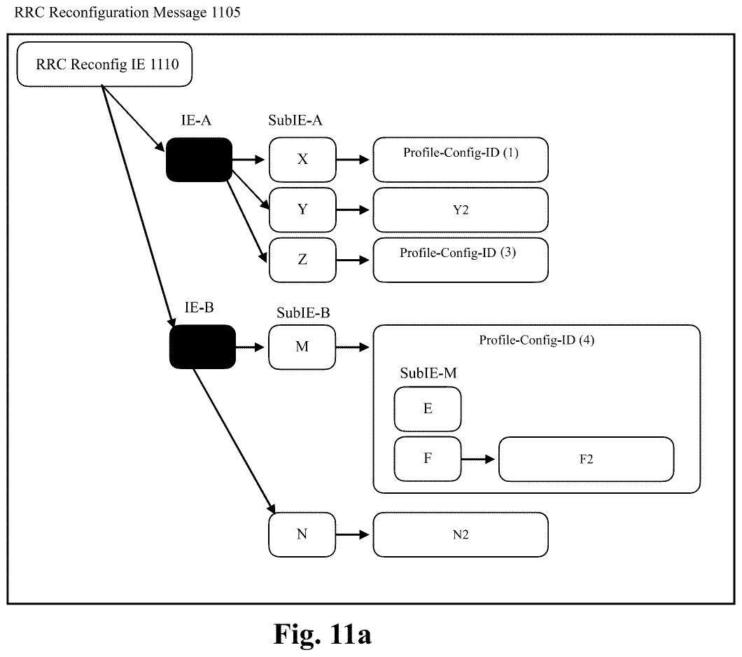

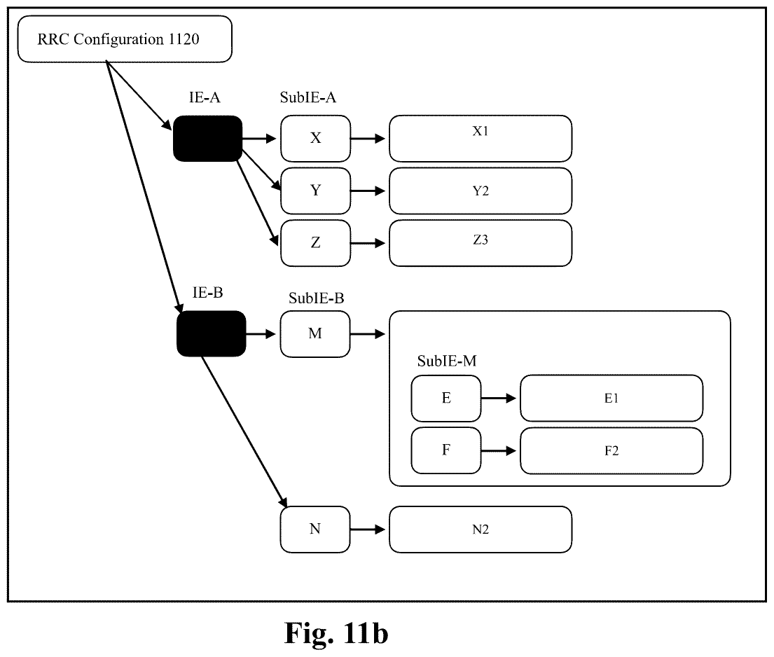

FIGS. 11a-11b illustrates an example of utilizing a configuration profile according to various exemplary embodiments. FIG. 11a shows an RRC reconfiguration message 1105. In this example, assume that the RRC reconfiguration message 1105 comprising RRC-Reconfig IE 1110 is received by the UE 110 while the RRC configuration 1020 of FIG. 10b is currently applied.

During operation, the network may transmit the RRC reconfiguration message 1105 comprising RRC-Reconfig IE 1110 to the UE 110. RRC-Reconfig IE 1110 includes at least the IE-A with sub-IEs X, Y and Z and IE-B with sub-IEs M and N. Sub-IE X is configured to include an indication that Profile-Config-ID (1) is to be utilized and sub-IE Z is configured to include an indication that Profile-Config-ID (3) is to be utilized. Sub-IE Y comprises configuration information Y2 and there is no Profile-Config parameter provided with sub-IE Y.

For IE-B, sub-IE M is configured to include an indication that Profile-Config-ID (4) is to be utilized. The network may dynamically modify the value of certain sub-IEs stored in a configuration profile by including an indication in the RRC-Reconfig IE. In this example, the RRC-Reconfig IE 1110 further include a value for sub-IE F of sub-IE M (e.g., F2). Thus, the network may indicate to the UE 110 that a particular configuration profile is to be utilized but one or more parameter values of the configuration profile are to be modified. Sub-IE N comprises configuration information N2 and There is no Profile-Config parameter provided with sub-IE N.

In response to the RRC reconfiguration message 1105, the UE 110 configures an RRC configuration 1120 as shown in FIG. 11b. The RRC configuration 1120 may apply configuration information included in the RRC-Reconfig IE 1110 and information stored in one or more configuration profiles.

In this example, the UE 110 may set the network configuration associated with sub-IE X to X1 because X1 is the configuration information stored in Profile-Config-ID (1). The UE 110 may set the network configuration associated with sub-IE Y to Y2 because Y2 is the configuration information provided in the RRC-Reconfig IE 1110. The UE 110 may set the network configuration associated with sub-IE Z to Z1 because Z1 is the configuration information stored in Profile-Config-ID (3). The UE 110 may set the network configuration associated with sub-IE M to M4 because M4 is the configuration information stored in Profile-Config-ID (4). M4 includes sub-IE E comprising network configuration information E1 and sub-IE F comprising network configuration information F1. However, since the value F2 was provided for sub-IE F in the RRC-Reconfig IE 1110, the value of sub-IE M in Profile-Config-ID (4) has been modified from F1 to F2. Thus, the UE 110 sets an RRC configuration 1120 comprising Sub-IE M with sub-IE E set to E1 and sub-IE F set to F2 and the Profile-Config-ID (4) entry stored locally at the UE 110 is to be overwritten to reflect this change as well. The UE 110 may set the network configuration associated with sub-IE N to N2 because N2 is the configuration information provided in the RRC-Reconfig IE 1110.

In another approach, a configuration profile list may be utilized. As will be described in more detail below, the configuration profile list (e.g., Profile-Config-List) may comprise one or more Profile-Config parameters. In this example, each Profile-Config parameter may include a Profile-Config-ID parameter configured to identify the corresponding configuration profile, an action parameter (Add/Mod/Remove) configured to trigger the UE 110 to add a new configuration profile to its local storage, modify a stored configuration profile or delete a stored configuration profile and a configuration path parameter configured to indicate a path to the selected IE comprising configuration information that is to be reused.

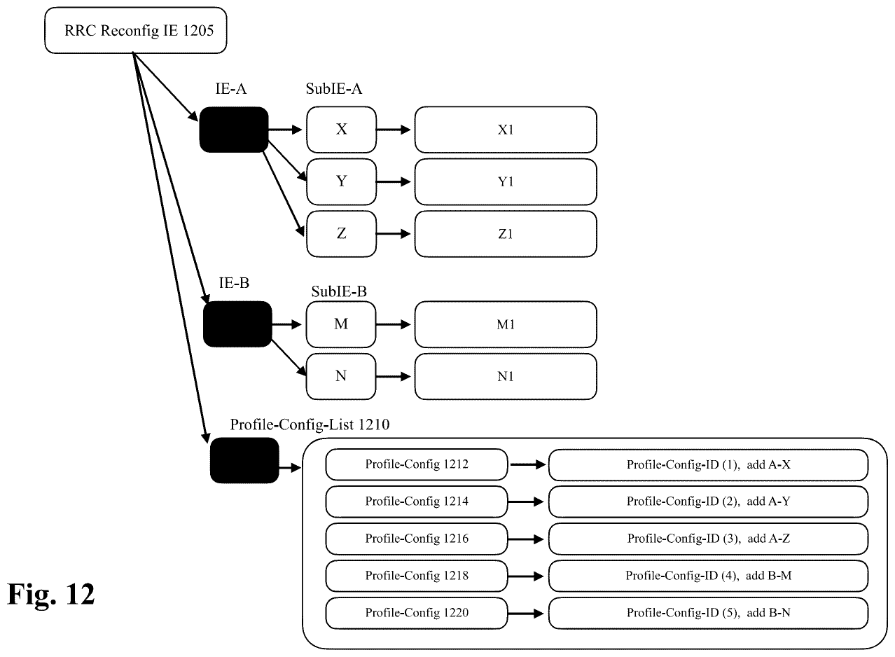

To create a predefined configuration profile using the configuration profile list approach, the network may provide the UE 110 with a message comprising an RRC container. The RRC container may include only IEs comprising configuration information that may be reused. The Profile-Config-List may also be provided. An example of this is described in more detail below with regard to FIG. 12.

FIG. 12 illustrates an example of a creating a configuration profile according to various exemplary embodiments.

During operation, the network may provision the UE 110 with one or more predefined configuration profiles. To convey this information to the UE 110, the network may provide the UE 110 with an RRC container comprising network configuration information that may be reused at a subsequent time. RRC-Reconfig IE 1205 comprises IE-A and IE-B. In this example, IE-A includes sub-IEs X, Y and Z each comprising configuration information X1, Y1 and Z1 respectively. IE-B includes sub-IEs M and N each comprising configuration information N1 and M1 respectively.

In addition, a Profile-Config-List 1210 may be provided that includes a list of Profile-Config parameters 1212-1220. The Profile-Config parameter 1212 includes a Profile-Config-ID parameter set to (1) and an indication that a configuration profile is to be stored at the UE 110 comprising a configuration path indicating a mapping between configuration information X1, sub-IE X and IE-A. The Profile-Config parameter 1214 includes a Profile-Config-ID parameter set to (2) and an indication that a configuration profile is to be stored at the UE 110 comprising a configuration path indicating a mapping between configuration information Y1, sub-IE Y and IE-A. The Profile-Config parameter 1216 includes a Profile-Config-ID parameter set to (3) and an indication that a configuration profile is to be stored at the UE 110 comprising a configuration path indicating a mapping between configuration information Z1, sub-IE Z and IE-A. The Profile-Config parameter 1218 includes a Profile-Config-ID parameter set to (4) and an indication that a configuration profile is to be stored at the UE 110 comprising a configuration path indicating a mapping between configuration information M1, sub-IE M and IE-B. The Profile-Config parameter 1220 includes a Profile-Config-ID parameter set to (5) and an indication that a configuration profile is to be stored at the UE 110 comprising a configuration path indicating a mapping between configuration information N1, sub-IE N and IE-B.

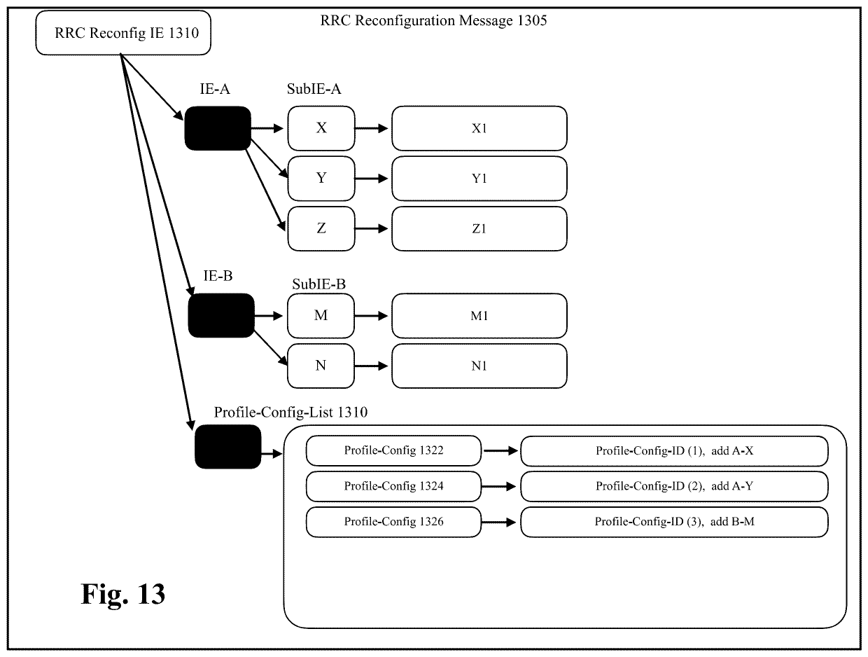

To create a dynamic configuration profile using the configuration profile list approach, the network may provide an RRC message to configure the UE 110. An example of this is described in more detail below with regard to FIG. 13.

FIG. 13 illustrates an example of creating a dynamic configuration profile according to various exemplary embodiments. Initially, assume an RRC reconfiguration message 1305 with an RRC-Reconfig IE 1310 is transmitted to the UE 110 to configure the UE 110. The RRC-Reconfig IE 1310 includes IE-A comprising sub-IEs X, Y and Z each comprising network configuration information X1, Y1 and Z1 respectively. The RRC-Reconfig IE 1310 also includes IE-B comprising sub-IEs M and N each comprising network configuration information M1 and N1 respectively.

The RRC-Reconfig IE 1310 may also include a Profile-Config-List 1320 with a list of Profile-Config parameters 1322-1326. The Profile-Config parameter 1322 includes a Profile-Config-ID parameter set to (1) and an indication that a configuration profile is to be stored at the UE 110 comprising a configuration path indicating a mapping between configuration information X1, sub-IE X and IE-A. The Profile-Config parameter 1324 includes a Profile-Config-ID parameter set to (2) and an indication that a configuration profile is to be stored at the UE 110 comprising a configuration path indicating a mapping between configuration information Z1, sub-IE Z and IE-A. The Profile-Config parameter 1326 includes a Profile-Config-ID parameter set to (3) and an indication that a configuration profile is to be stored at the UE 110 comprising a configuration path indicating a mapping between configuration information M1, sub-IE M and IE-B. In this example, sub-IEs Y and N are not to reused from a stored configuration profile and thus, are not included in the Profile-Config-List.

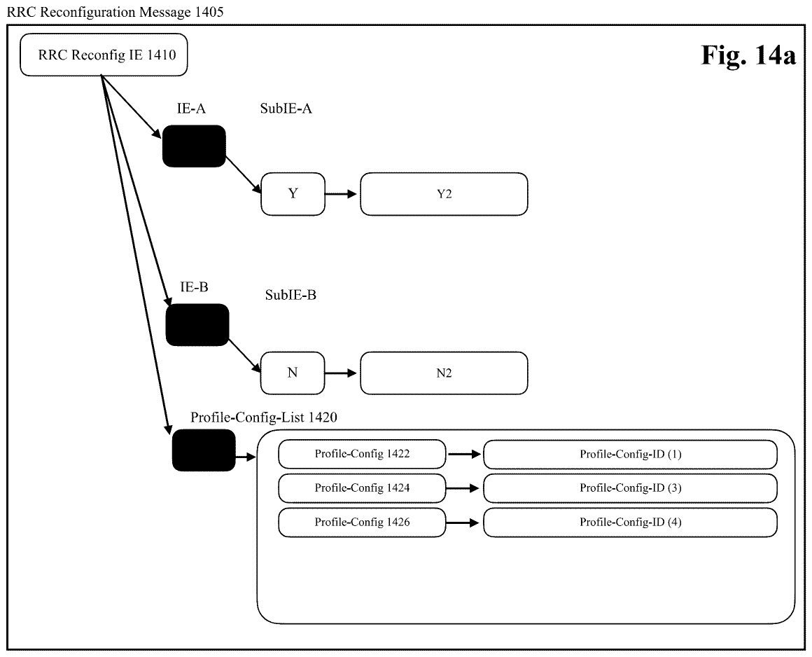

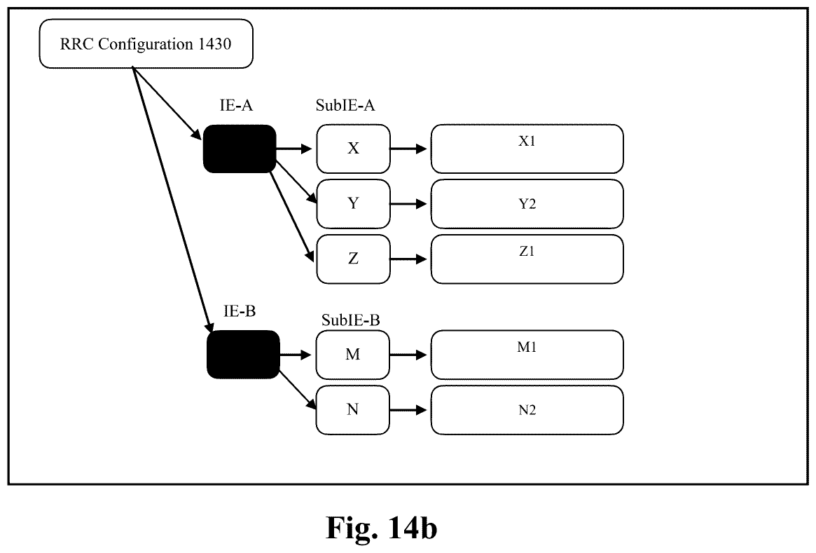

FIGS. 14a-14b illustrate an example of utilizing a configuration profile according to various exemplary embodiments. Initially, assume that the UE 110 has multiple configuration profiles stored in a local database each corresponding to a different Profile-Config-ID. The configuration profiles may be predefined configuration profiles, dynamic configuration profiles or a combination thereof.

FIG. 14a shows an RRC reconfiguration message 1405. During operation, the network may transmit an RRC reconfiguration message 1405 with an RRC-Reconfig IE 1410 to the UE 110. RRC-Reconfig IE 1410 includes at least IE-A with sub-IE Y comprising network configuration information (Y2) and IE-B with sub-IE N comprising network configuration information (N2). The RRC-Reconfig IE 1410 also includes a Profile-Config-List 1420 comprising Profile-Config parameters 1422-1426. Profile-Config 1422 comprises a Profile-Config-ID set to (1) which corresponds to a configuration profile with a mapping between X1, sub-IE X and IE-A. Profile-Config 1424 comprises a Profile-Config-ID set to (3) which corresponds to a configuration profile with a mapping between Z1, sub-IE Z and IE-A. Profile-Config 1426 comprises a Profile-Config-ID (4) which corresponds to a configuration profile with a mapping between M1, sub-IE M and IE-B.

In response to the RRC reconfiguration message 1405, the UE 110 sets an RRC configuration 1430 as shown in FIG. 14b. The RRC configuration 1430 may include configuration information provided in the RRC-Reconfig IE 1410 and stored in one or more configuration profiles.

In this example, the UE 110 may set the network configuration associated with sub-IE X to X1 because X1 is the configuration information stored in Profile-Config-ID (1). The UE 110 may set the network configuration associated with sub-IE Y to Y2 because Y2 is the configuration information provided in the RRC-Reconfig IE 1410. The UE 110 may set the network configuration associated with sub-IE Z to Z1 because Z1 is the configuration information stored in Profile-Config-ID (3). the UE 110 may set the network configuration associated with sub-IE M to M1 because M1 is the configuration information stored in Profile-Config-ID (4). The UE 110 may set the network configuration associated with sub-IE N to N2 because N2 is the configuration information provided in the RRC-Reconfig IE 1410.

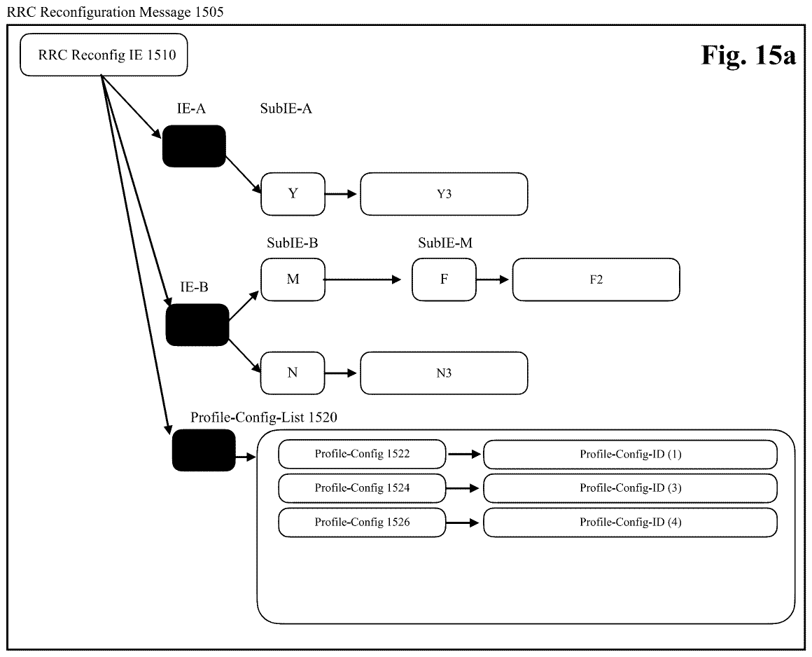

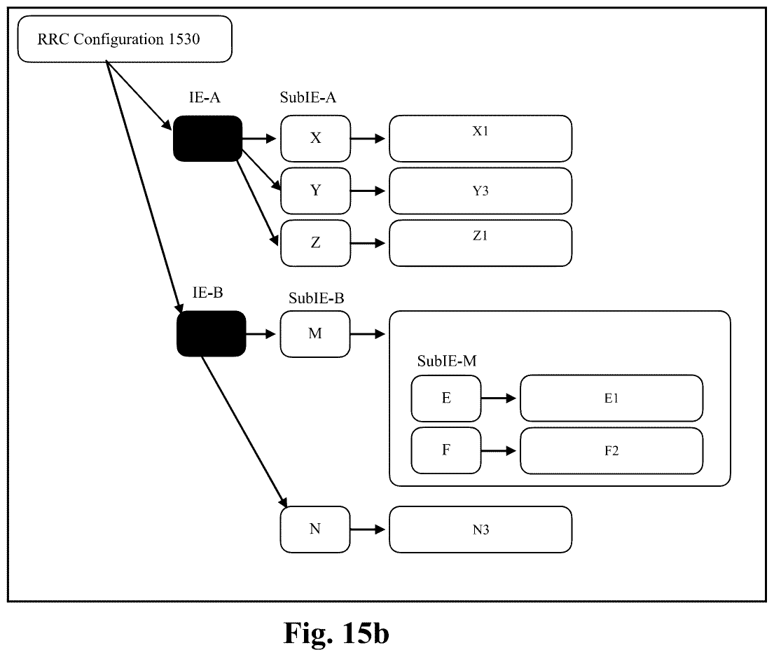

FIGS. 15a-15b illustrate an example of utilizing a configuration profile according to various exemplary embodiments. In this example, assume that an RRC reconfiguration message 1505 comprising RRC-Reconfig IE 1510 is received by the UE 110 while the RRC configuration 1430 of FIG. 14b is currently applied.

FIG. 15a shows an RRC reconfiguration message 1505. During operation, the network may transmit an RRC reconfiguration message 1505 comprising RRC-Reconfig IE 1510 to the UE 110. RRC-Reconfig IE 1510 includes IE-A with sub-IE Y comprising network configuration information Y3.

IE-B includes sub-IE N comprising configuration information N3. In addition, IE-B includes sub-IE M. The network may dynamically modify the value of certain sub-IEs stored in a configuration profile by including an indication in the RRC-Reconfig IE 1510. In this example, the RRC-Reconfig IE 1510 further includes network configuration information F2 for sub-IE F of sub-IE M. As will be described in more detail below, this may trigger the UE 110 to update a configuration profile to include the configuration information F2.

The RRC-Reconfig IE 1510 further includes a Profile-Config-List 1520 comprising Profile-Config 1522-1526. The Profile-Config 1522 indicates a Profile-Config-ID set to (1) which corresponds to sub-IE X and Profile-Config 1524 indicates a Profile-Config-ID set to (3) which corresponds to sub-IE Z. The Profile-Config 1526 includes a Profile-Config-ID set to (4) which corresponds to sub-IE M.

In response to the RRC reconfiguration message 1505, the UE 110 set an RRC configuration 1530 as shown in FIG. 15b. The RRC configuration 1530 may apply configuration information included in the RRC-Reconfig IE 1510 and stored in one or more configuration profiles.

In this example, the UE 110 may set the network configuration associated with sub-IE X to X1 because X1 is the configuration information stored in Profile-Config-ID (1). The UE 110 may set the network configuration associated with sub-IE Y to Y3 because Y3 is the configuration information provided in the RRC-Reconfig IE 1510. The UE 110 may set the network configuration associated with sub-IE Z to Z1 because Z1 is the configuration information stored in Profile-Config-ID (3).

For sub-IE M, the UE 110 may set sub-IE E to El because El is the network configuration stored in the configuration profile identified by the Profile-Config-ID set to (4). In this example, the network provided a value for sub-IE F to trigger the UE 110 to apply the configuration information F2 to its RRC configuration 1530 and modify the contents of the configuration profile identified by the Profile-Config-ID (3) to change the value for sub-IE F from a first value (e. g., F1) to the value indicated in the RRC-Reconfig IE 1510 (e.g., F2). The UE 110 may set the network configuration associated with sub-IE N to N3 because N3 is the configuration information provided in the RRC-Reconfig IE 1510.

It has been identified that it may be beneficial to utilize a configuration profile for secondary cell (SCell) related network configuration information. Typically, when the network sends an RRC message to add an SCell or modify an SCell configuration many of the parameters are repeated among the SCells within the same RRC configuration message. Without a mechanism to reuse the configuration information among the SCells in the same RRC reconfiguration message, the network may be triggered to provide a message that comprises a relatively significant amount of redundant information. The exemplary embodiments introduced herein may allow the network to reuse configurations among the SCells in a same RRC reconfiguration message. In some of the examples provided below, the IEs and sub-IEs are characterized as being related to SCell operation (e.g., SCellConfig, ServingCellConfig, etc.). While it may be beneficial to implement a configuration profile for this type of network configuration information, the exemplary embodiments are not limited to SCell operation. A configuration profile may be applied to any set of one or more IEs.

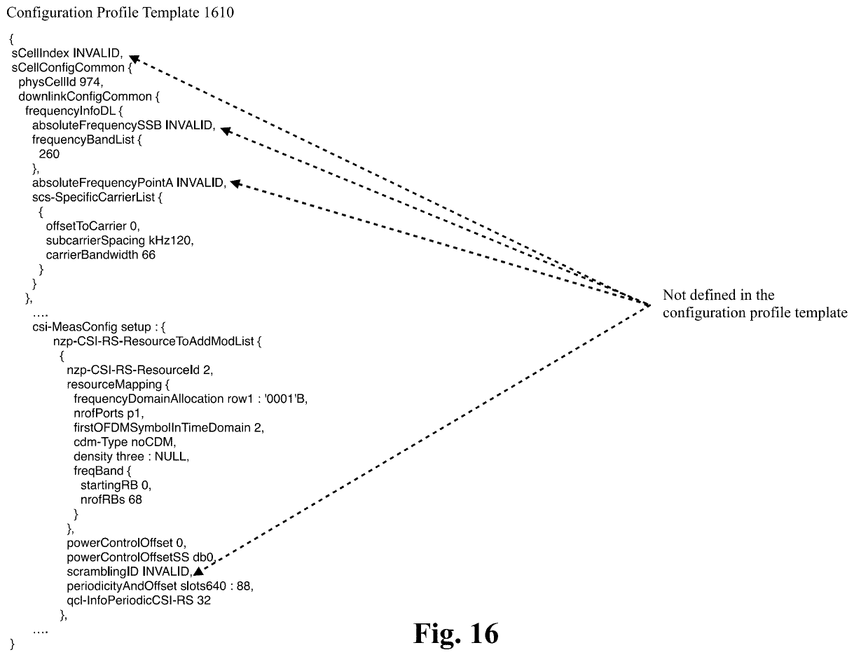

According to some aspects, a configuration profile may be defined using a template. The template may represent a set of configurations with defined values except for one or more IEs that are configured with undefined values. During operation, when the configuration profile is to be used, the configuration information shall be applied in accordance with a configuration profile template. The undefined IEs in the template may be defined in the configuration applied at the UE 110 using any appropriate source outside of the configuration profile template. An example of a template-based approach is described in more detail below with regard to FIG. 16.

FIG. 16 shows an example of configuration profile template 1610 according to various exemplary embodiments. The configuration profile template 1610 comprises multiple IEs with defined values except for the following IEs which are undefined: SCellIndex, absoluteFrequency SSB, ansoluteFrequnecyPointA and scramblingID. In this example, an IE is marked as invalid if it is not defined in the template. In an actual deployment scenario, the UE 110 may utilize any appropriate type of indication or mechanism to manage undefined IEs in configuration profile templates.

The UE 110 may store configuration profile templates in a local database with an identifier (e.g., profile ID, etc.). In this example, the identifier Profile-Config-Template-ID for this template is set to (1). The UE 110 may then be triggered to apply a store configuration profile template in certain scenarios. In some embodiments, one or more templates may be predefined and provided to the UE 110 prior to establishing an RRC connection. In other embodiments, one or more configuration profile templates may be provided in an RRC message.

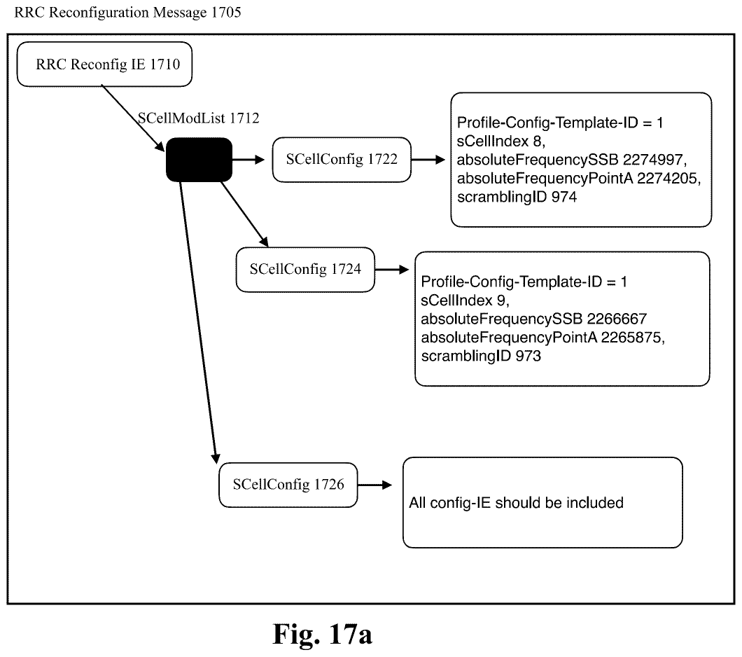

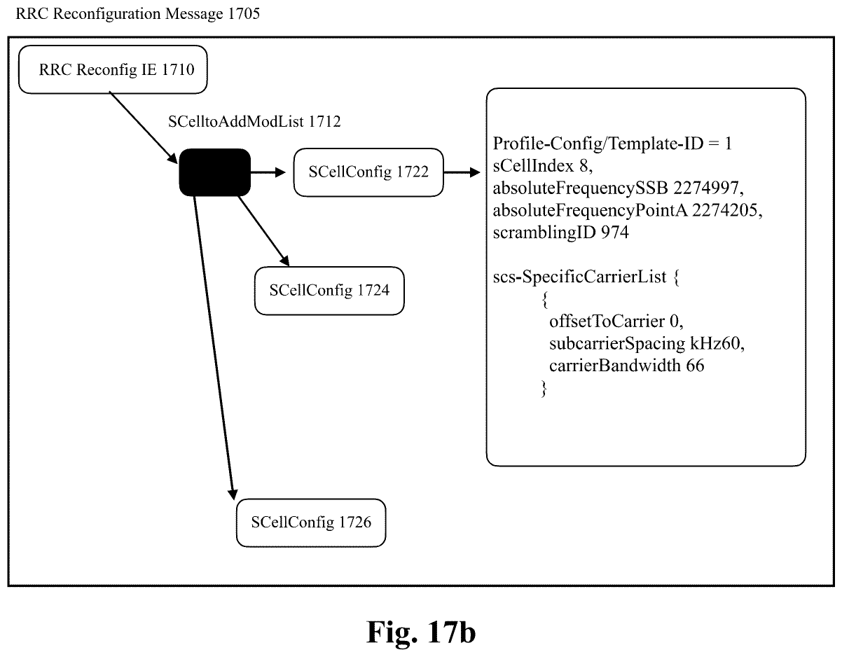

FIGS. 17a-17b show an example of utilizing a configuration profile template according to various exemplary embodiments. In this example, the network transmits an RRC reconfiguration message 1705 as shown in 1722a to the UE 110 comprising at least an RRC-Reconfig IE 1710 with a SCelltoAddModList IE 1712. The SCelltoAddModList IE 1720 may comprise a first SCellConfig IE 1722 for a first SCell, a second SCellConfig IE 1724 for a second SCell and a third SCellConfig IE 1726 for a third SCell. SCellConfig IE 1722 includes a Profile-Config-Template-ID set to (1) which indicates to the UE 110 which configuration profile template stored locally at the UE 110 is to be used. In addition, the SCellConfig IE 1722 includes the parameter values for parameters that are not defined in the stored configuration profile template. When the UE 110 applies the configuration information, the UE 110 may utilize the parameter values provided in SCellConfig IE 1722 and the corresponding configuration profile template. Similarly, SCellConfig IE 1724 includes a Profile-Config-Template-ID set to (1) which indicates to the UE 110 which configuration profile template is to be used. SCellConfig IE 1724 includes the parameters that are not defined in the stored configuration profile template. When the UE 110 applies the configuration information, the UE 110 may utilize the parameter values provided in SCellConfig IE 1724 and the corresponding configuration profile template. The SCellConfig IE 1726 does not include a Profile-Config-Template-ID and/or an indication that a configuration profile template is not to be used for this IE. Since a configuration profile template is not being used for SCellConfig IE 1726 the network shall provide the configuration information for all of the IEs in SCellConfig IE 1726.

In some embodiments, the network may overwrite a parameter value stored in a configuration profile template. An example of this is shown in FIG. 117b where the network provides a Profile-Config-Template-ID set to (1) in SCellConfig IE 1722 indicating to the UE 110 which configuration profile template stored locally at the UE 110 is to be used. In addition, the SCellConfig IE 1722 includes the parameter values for the IEs that are undefined in the stored configuration profile template and configuration information that is to be used to overwrite configuration information currently stored in the configuration profile template. In this example, the scs-SpecifcCarrierList IE saved in the configuration profile template with Profile-Config-Template-ID set to (1) is to be overwritten with the information provided in the SCellConfig IE 1722. Thus, by providing parameter values for a parameter already defined in a configuration profile template, the network may modify (e.g., add, change, delete, etc.) the contents of a configuration profile template stored locally at the UE 110.

### EXAMPLES

In a first example, a method performed by a user equipment (UE), comprising storing one or more configuration profiles in a local database comprising at least a first configuration profile, wherein the first configuration profile includes a set of network configuration parameters and corresponding values and receiving a message from a network, the message indicating that the UE is to apply the set of network configuration parameters and corresponding values stored in the first configuration profile to at least a portion network configuration.

In a second example, the method of the first example, wherein the first configuration profile is a hard-encoded default configuration profile.

In a third example, the method of the first example, further comprising receiving the first configuration profile based on entering a geographical location, wherein the first configuration profile is provided in a system information block (SIB) or using a push configuration message transported over a data plane.

In a fourth example, the method of the first example, wherein the first configuration profile is stored on a subscriber identity module (SIM).

In a fifth example, the method of the first example, further comprising receiving an indication that the first configuration profile is to be stored locally at the UE.

In a sixth example, the method of the fifth example, wherein the indication is provided in an information element (IE) of a radio resource control (RRC) message.

In a seventh example, the method of the sixth example, wherein the indication is a profile ID tagged to the IE.

In an eighth example, the method of the first example, further comprising receiving an indication that the first configuration profile stored locally at the UE is to be modified.

In a ninth example, the method of the eighth example, wherein the indication is provided in a radio resource control (RRC) reconfiguration message.

In a tenth example, the method of the first example, further comprising selecting the first configuration profile based on a condition and transmitting an indication of the selected first configuration profile to the network.

In an eleventh second example, the method of the first example, further comprising receiving a radio resource control (RRC) container comprising a plurality of information elements (IEs), wherein each IE included in the RRC container is to be stored in the one or more configuration profiles.

In a twelfth example, the method of the eleventh example, wherein a first IE of the plurality of IEs includes an identifier for a configuration profile that is to be stored locally at the UE.

In a thirteenth example, the method of the first example, further comprising receiving a radio resource control (RRC) reconfiguration message comprising a plurality of information elements (IEs), wherein a first IE of the plurality of IEs includes configuration information an identifier for a configuration profile that is to be stored locally at the UE.

In a fourteenth example, the method of the first example, further comprising receiving a radio resource control (RRC) reconfiguration message comprising a plurality of information elements (IEs), wherein a first IE of the plurality of IEs includes an identifier for a configuration profile stored locally at the UE and does not include a parameter value for the first IE.

In a fifteenth example, the method of the first example, further comprising receiving a radio resource control (RRC) reconfiguration message comprising a plurality of information elements (IES), wherein a first IE of the plurality of IEs includes an identifier for a configuration profile stored locally at the UE and only a subset of parameter values for the first IE.

In a sixteenth example, the method of the fifteenth example, wherein the UE modifies the configuration profile to include the subset of parameter values for the first IE.

In a seventeenth example, the method of the first example, further comprising receiving a radio resource control (RRC) container comprising a plurality of information elements (IEs) and a configuration profile list, wherein the configuration profile list includes a parameter comprising an identifier for a configuration profile to be stored locally at the UE.

In an eighteenth example, the method of the seventeenth example, wherein a first IE of the plurality of IEs corresponds to the parameter comprising the identifier.

In a nineteenth example, the method of the first example, further comprising receiving a radio resource control (RRC) reconfiguration message comprising a plurality of information elements (IEs) and a configuration profile list, wherein the configuration profile list includes a parameter comprising an identifier for a configuration profile to be stored locally at the UE and is associated with at least a first IE of the plurality of IEs.

In a twentieth example, the method of the first example, further comprising receiving a radio resource control (RRC) reconfiguration message comprising a plurality of information elements (IEs) and a configuration profile list, wherein the configuration profile list includes a parameter comprising an identifier for a configuration profile stored locally at the UE.

In a twenty first example, the method of the first example, further comprising receiving a radio resource control (RRC) reconfiguration message comprising a plurality of information elements (IEs) and a configuration profile list, wherein a first IE of the plurality of IEs includes a subset of parameter values for the first IE.

In a twenty second example, the method of the twenty first example, wherein the UE modifies the configuration profile to include the subset of parameter values from the first IE.

In a twenty third example, the method of the first example, wherein the first configuration profile further comprises a set of parameters that are not defined in the configuration profile.

In a twenty fourth example, the method of the twenty third example, further comprising receiving a radio resource control (RRC) reconfiguration message comprising at least a first information element (IE), the first IE including an identifier associated with the first configuration profile and network configuration information for the set of parameters that are not defined in the first configuration profile.

In a twenty fifth example, the method of the twenty third example, wherein the RRC reconfiguration message further comprises network configuration information for a parameter that is defined in the first configuration profile, wherein the UE modifies a value of the parameter in the first configuration profile based on the network configuration information.

In a twenty sixth example, the method of the first example, further comprising receiving the one or more configuration profiles from a second network.

In a twenty seventh example, the method of the twenty sixth example, wherein the network and the second network are the same network.

In a twenty eighth example, the method of the twenty sixth example, wherein the network and the second network are different networks.

In a twenty ninth example, the method of the first example, wherein each of the one or more configuration profiles are stored as a compressed abstract syntax notation one (ASN.1) encoded radio resource control (RRC) configuration.

In a thirtieth example, the method of the twenty ninth example, further comprising entering RRC configured mode, wherein the UE decompresses the one or more configuration profiles, prior to receiving the message, in response to entering the RRC connected mode.

In a thirty first example, the method of the first example, further comprising transmitting UE capability information to the network, the UE capability information comprising an indication of a number of configuration profiles the UE is configured to support.

In a thirty second example, the method of the thirty first example, wherein the UE capability information further comprises a parameter indicating a total size of all configuration profiles in abstract syntax notation one (ASN.1) encoded format that the UE is configured to store.

In a thirty third example, the method of the first example, wherein the message is a radio resource control (RRC) reconfiguration message comprising one or more information element (IEs) that each include an identifier corresponding to a configuration profile stored locally at the UE.

In a thirty fourth example, the method of the first example, wherein the message further indicates that an additional parameter and corresponding parameter value is to be added to the first configuration profile.

In a thirty fifth example, the method of the first example, wherein the message further indicates that a first value of a first parameter stored in the first configuration profile is to be changed from the first value to a second different value.

In a thirty sixth example, the method of the first example, wherein the message further indicates that a first parameter and corresponding parameter value is to be deleted from the first configuration profile.

In a thirty seventh example, the method of the first example, wherein the first configuration profile is stored in the local database during a time window and deleted from the local database when the time window expires.

In a thirty eighth example, the method of the first example, wherein the first configuration profile is stored in the local database when the UE is deployed in a first location and deleted from the local database when the exits the first location.

In a thirty ninth example, the method of the first example, wherein the UE is configured to utilize first configuration profile only when the UE is deployed in a first radio access network (RAN) area.

In a fortieth example, the method of the first example, wherein the UE is configured to utilize first configuration profile only when the UE is deployed in a first tracking area (TA).

In a forty first example, the method of the first example, wherein the UE is configured to utilize the first configuration profile in any radio access network (RAN) area.

In a forty second example, the method of the first example, wherein the UE is configured to utilize the first configuration profile in any tacking area (TA).

In a forty third example, the method of the first example, wherein the first configuration profile is maintained in the local database only when the UE is in radio resource control (RRC) connected mode or RRC inactive mode.

In a forty fourth example, the method of the first example, wherein the first configuration profile is maintained in the local database indefinitely.

In a forty fifth example, a processor configured to perform any of the methods of the first through forty fourth examples.

In a forty sixth example, a user equipment (UE) comprising a transceiver configured to communicate with a network and a processor communicatively coupled to the transceiver and configured to perform any of the methods of the first through forty fourth examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above-described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. An apparatus of a user equipment (UE), the apparatus comprising processing circuitry configured to:
store one or more configuration profiles in a local database comprising at least a first configuration profile, wherein the first configuration profile includes a set of network configuration parameters and corresponding values; and
decode, based on signals signaling received from a network, a message indicating that the UE is to apply the set of network configuration parameters and corresponding values stored in the first configuration profile to at least a portion network configuration.

2. The apparatus of claim 1, wherein the first configuration profile is (i) a hard-encoded default configuration profile, (ii) received based on entering a geographical location, or (iii)stored on a subscriber identity module (SIM).

3. The apparatus of claim 1, wherein the processing circuitry is further configured to:
decode, based on signals signaling received from the network, a radio resource control (RRC) reconfiguration message comprising a plurality of information elements (IEs) and a configuration profile list, wherein the configuration profile list includes a parameter comprising an identifier for the first configuration profile to be stored locally at the UE and is associated with at least a first IE of the plurality of IEs.

4. The apparatus of claim 1, wherein the first configuration profile comprises a profile identification (ID) and a reference to the set of parameters included in the message.

5. The apparatus of claim 1, wherein the processing circuitry is further configured to:
decode, based on signals signaling received from the network, a radio resource control (RRC) reconfiguration message comprising an indication that the first configuration profile stored locally at the UE is to be modified.

6. The apparatus of claim 1, wherein the first configuration profile is modified by (i) modifying only a subset of parameter values, (ii) adding an additional parameter and corresponding parameter value, (iii) modifying a first parameter from a first value to a second different value or (iv) deleting a first parameter and corresponding parameter value.

7. The apparatus of claim 1, wherein the processing circuitry is further configured to:
decode, based on signals signaling received from the network, an indication that the first configuration profile is to be deleted and a second configuration profile is to be added to the UE.

8. The apparatus of claim 1, wherein the processing circuitry is further configured to:
select the first configuration profile based on a condition; and
configure transceiver circuitry to transmit generate an indication of the selected first configuration profile to the network.

9. The apparatus of claim 1, wherein the processing circuitry is further configured to:
decode, based on signals signaling received from the network, a radio resource control (RRC) container comprising a plurality of information elements (IEs), wherein each IE included in the RRC container is to be stored in the one or more configuration profiles.

10. The apparatus of claim 1, wherein the processing circuitry is further configured to:
decode, based on signals signaling received from the network, a radio resource control (RRC) reconfiguration message comprising a plurality of information elements (IEs), wherein a first IE of the plurality of IEs includes an identifier for the first configuration profile stored locally at the UE and does not include a parameter value for the first IE.

11. The apparatus of claim 1, wherein the first configuration profile further comprises a set of parameters without associated values in the one or more configuration profiles.

12. The apparatus of claim 11, wherein the processing circuitry is further configured to:
decode, based on signals signaling received from the network, a radio resource control (RRC) reconfiguration message comprising at least a first information element (IE), the first IE including an identifier associated with the first configuration profile and network configuration information for the set of parameters without associated values in the first configuration profile.

13. The apparatus of claim 1, wherein the processing circuitry is further configured to:
decode, based on signals signaling received from a second network, the one or more configuration profiles, wherein the network and the second network are (i) a same network or (ii) different networks.

14. The apparatus of claim 1, wherein the processing circuitry is further configured to:
configure transceiver circuitry to transmit generate, for transmission to the network, UE capability information to the network, the UE capability information comprising an indication of a number of configuration profiles the UE is configured to support and a parameter indicating a total size of all configuration profiles in abstract syntax notation one (ASN.1) encoded format that the UE is configured to store.

15. The apparatus of claim 1, wherein the first configuration profile is stored in the local database (i) during a time window and deleted from the local database when the time window expires, (ii) when the UE is deployed in a first location and deleted from the local database when the UE exits the first location or (iii) is maintained in the local database indefinitely.

16. The apparatus of claim 1, wherein the UE is configured to utilize first configuration profile (i) only when the UE is deployed in a first radio access network (RAN) area, (ii) only when the UE is deployed in a first tracking area (TA), (iii) in any RAN area or (iv) in any TA.

17. The apparatus of claim 1, wherein the first configuration profile is maintained in the local database only when the UE is in radio resource control (RRC) connected mode or RRC inactive mode.

18. The apparatus of claim 1, wherein the processing circuitry is further configured to:
decode, based on signals signaling received from the network, a radio resource control (RRC) message comprising an information element (IE) including an indication that the first configuration profile is to be stored locally at the UE, wherein the indication is a profile ID tagged to the IE.

19. The apparatus of claim 1, wherein each of the one or more configuration profiles are stored as a compressed abstract syntax notation one (ASN.1) encoded radio resource control (RRC) configuration.

20. The apparatus of claim 19, wherein the processing circuitry is further configured to:
enter RRC connected mode, wherein the UE decompresses the one or more configuration profiles, prior to receiving the message, in response to entering the RRC connected mode.
